(19) United States
(12) Patent Application Publication
(10) Pub. No.: US 2016/0052503 A1
(43) Pub. Date: Feb. 25, 2016

(54) APPARATUS INCLUDING USER-PLATFORM ASSEMBLY AND AIR-THRUSTING ASSEMBLY AND METHOD THEREFOR

(71) Applicants: Cameron HOWELL, Calgary (CA); Paul OSTLUND, Regina (CA); Anuj SARASWAT, Edmonton (CA)

(72) Inventors: Cameron HOWELL, Calgary (CA); Paul OSTLUND, Regina (CA); Anuj SARASWAT, Edmonton (CA)

(21) Appl. No.: 14/467,737

(22) Filed: Aug. 25, 2014

(51) Int. Cl. B60V 1/14; B60V 1/18

(52) U.S. Cl. CPC B60V 1/14; B60V 1/18

(57) ABSTRACT

An apparatus is to be operated relative to a working surface; the apparatus includes a user-platform assembly configured to support a user in response to the user positioned on the user-platform assembly; an air-thrusting assembly operatively coupled to the user-platform assembly, and the air-thrusting assembly configured to thrust air along: a first direction relative to the working surface in such a way that the air-thrusting assembly urges the user-platform assembly to vertically hover, at least in part, over the working surface; and a second direction relative to the working surface in such a way that the user-platform assembly travels, at least in part, horizontally along the working surface while the air-thrusting assembly urges the user-platform assembly to vertically hover, at least in part, over the working surface.

### TECHNICAL BACKGROUND

Some aspects generally relate to (and are not limited to) an apparatus including a user-platform assembly and an air-thrusting assembly (and method therefor).

### SUMMARY

In view of the foregoing, it will be appreciated that there exists a need to mitigate (at least in part) problems associated with systems for transporting a person. After much study of the known systems and methods along with experimentation, an understanding of the problem and its solution has been identified and is articulated below.

In order to mitigate, at least in part, the problem(s) identified with existing systems and/or methods for transporting a person, there is provided (in accordance with an aspect) an apparatus to be operated relative to a working surface; the apparatus includes: a user-platform assembly configured to support a user in response to the user positioned (such as, standing) on the user-platform assembly; an air-thrusting assembly operatively coupled to the user-platform assembly, and the air-thrusting assembly configured to thrust air along: (A) a first direction relative to the working surface in such a way that the air-thrusting assembly urges the user-platform assembly to vertically hover, at least in part, over the working surface; and (B) a second direction relative to the working surface in such a way that the user-platform assembly travels, at least in part, horizontally along the working surface while the air-thrusting assembly urges the user-platform assembly to vertically hover, at least in part, over the working surface.

In order to mitigate, at least in part, the problem(s) identified above, in accordance with an aspect, there is provided a method for operating an apparatus relative to a working surface; the method includes: supporting a user on a user-platform assembly; thrusting air along a first direction relative to the working surface from an air-thrusting assembly operatively coupled to the user-platform assembly, in such a way that the air-thrusting assembly urges the user-platform assembly to vertically hover, at least in part, over the working surface; and thrusting air along a second direction relative to the working surface from the air-thrusting assembly, in such a way that the user-platform assembly travels, at least in part, horizontally along the working surface while the air-thrusting assembly urges the user-platform assembly to vertically hover, at least in part, over the working surface.

In order to mitigate, at least in part, the problem(s) identified above, in accordance with an aspect, there is provided other aspects as identified in the claims.

Other aspects and features of the non-limiting embodiments may now become apparent to those skilled in the art upon review of the following detailed description of the non-limiting embodiments with the accompanying drawings.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIGS. 1a to 1d (SHEETS 1 to 2 of 10 SHEETS) depict views of embodiments of an apparatus to be operated relative to a working surface;

FIGS. 2a to 2j (SHEETS 3 to 5 of 10 SHEETS) depict views of embodiments of the apparatus of FIGS. 1a to 1d;

FIGS. 3a to 3c (SHEETS 6 to 7 of 10 SHEETS) depict views of embodiments of the apparatus of FIGS. 1a to 1d;

FIG. 4 (SHEET 8 of 10 SHEETS) depicts a schematic view of an embodiment of the apparatus of FIGS. 1a to 1d;

FIG. 5 (SHEET 9 of 10 SHEETS) depicts a view of an embodiment of the apparatus of FIGS. 1a to 1d; and

FIGS. 6A and 6B (SHEET 10 of 10 SHEETS) depict views of embodiments of the apparatus of FIGS. 1a to 1d.

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

Corresponding reference characters indicate corresponding components throughout the several figures of the Drawings. Elements in the several figures are illustrated for simplicity and clarity and have not necessarily been drawn to scale. For example, the dimensions of some of the elements in the figures may be emphasized relative to other elements for facilitating an understanding of the various presently disclosed embodiments. In addition, common, but well-understood, elements that are useful or necessary in commercially feasible embodiments are often not depicted in order to facilitate a less obstructed view of the various embodiments of the present disclosure.

### LISTING OF REFERENCE NUMERALS USED IN THE DRAWINGS

100 apparatus

102 user-platform assembly

104 air-thrusting assembly

106 interior chamber

107 outer-facing exterior surface

108 first interior chamber

110 second interior chamber

116 first surface portion

118 air-in portal

119 filter

120 bottom portion

122 air-out portal

123 lip

124 opposite sides

126 side-facing surface

128 top-facing surface

130 inter-cavity barrier

132 first direction

134 second direction

136 outer perimeter

138 skirt

140 intake direction

142 outtake direction

144 intake direction

146 outtake direction

148 house chamber

150 battery chamber

152 first section

154 second section

156 centering device

158 rotation axis

160 airflow

200 first air-thrusting device

202 vertically-aligned fan

204 vertical-thrust motor assembly

206 coupling mechanism

208 battery assembly

300 second air-thrusting device

302 horizontally-aligned fan

304 horizontal section

306 first tubular unit

308 second tubular unit

310 first interior cavity

312 second interior cavity

314 air intake

315 filter

316 air outtake

320 horizontal-thrust motor

322 horizontal-thrust shaft

324 control switch

326 biasing mechanism

328 air inflow direction

330 air outflow direction

400 control circuit

402 first fuse assembly

403 second fuse assembly

404 electrical conductors

406 power switch

502 first longitudinally-extending interior chamber

504 second longitudinally-extending interior chamber

506 third longitudinally-extending interior chamber

508 first horizontal interior wall

510 second horizontal interior wall

900 working surface

902 user

### DETAILED DESCRIPTION OF THE NON-LIMITING EMBODIMENT(S)

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of the description herein, the terms “upper,” “lower,” “left,” “rear,” “right,” “front,” “vertical,” “horizontal,” and derivatives thereof shall relate to the examples as oriented in the drawings. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments (examples), aspects and/or concepts defined in the appended claims. Hence, specific dimensions and other physical characteristics relating to the embodiments disclosed herein are not to be considered as limiting, unless the claims expressly state otherwise. It is understood that “at least one” is equivalent to “a”. The aspects (examples, alterations, modifications, options, variations, embodiments and any equivalent thereof) are described with reference to the drawings. It should be understood that the invention is limited to the subject matter provided by the claims, and that the invention is not limited to the particular aspects depicted and described.

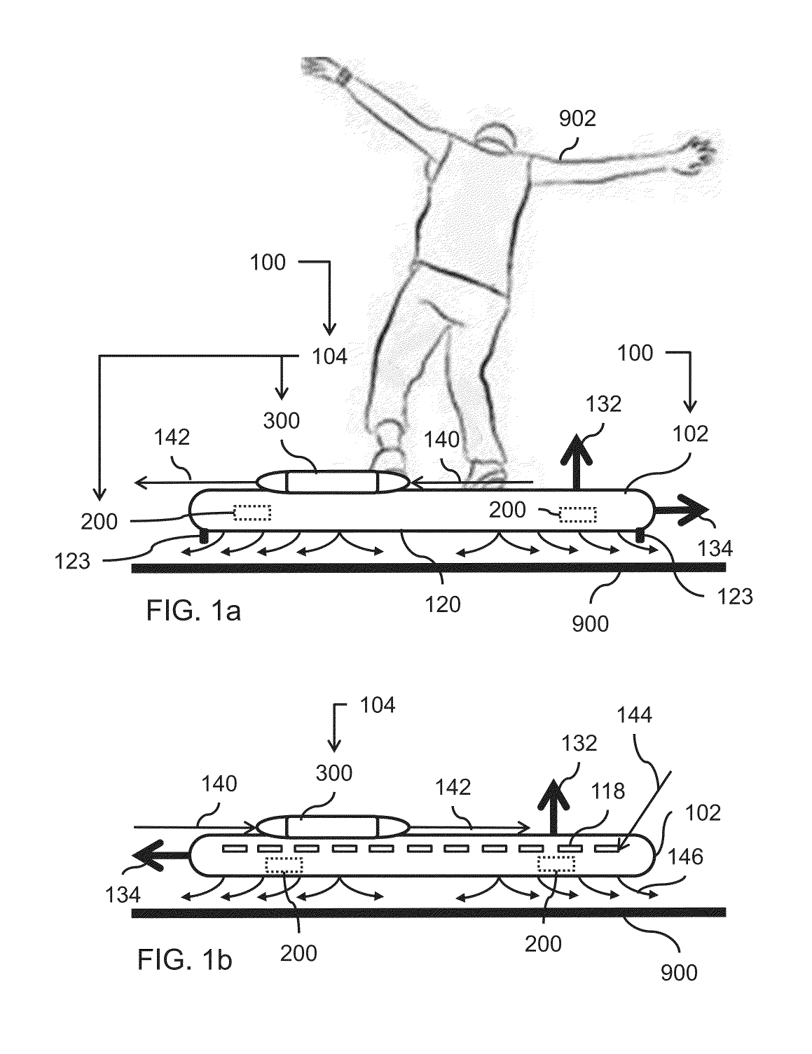

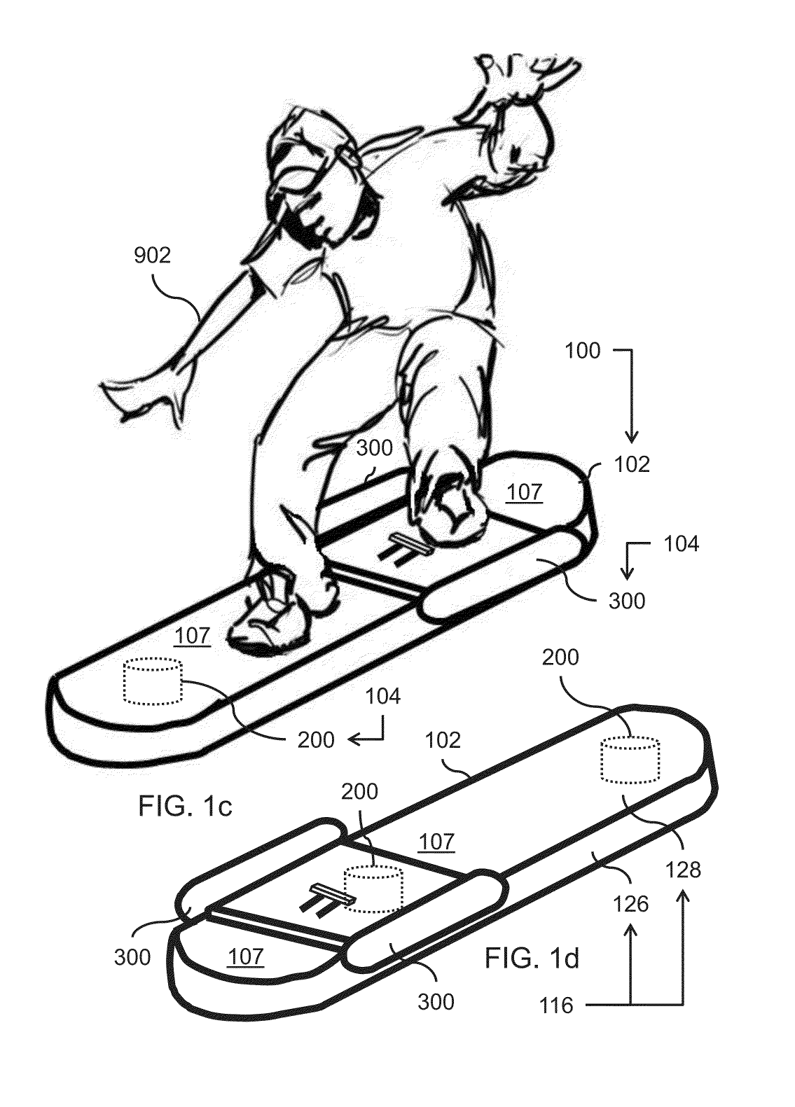

FIGS. 1a to 1d depict views of embodiments of an apparatus 100 to be operated relative to a working surface 900. FIGS. 1a and 1b depict side views. FIGS. 1c and 1d depict perspective views (a frontal view and a rearward view, respectively). FIG. 1a depicts the apparatus 100 travelling along a forward horizontal direction. FIG. 1b depicts the apparatus 100 travelling along a reversed horizontal direction.

Referring to the embodiments depicted in FIGS. 1a and 1b, the apparatus 100 is to be operated relative to the working surface 900. The working surface 900 includes water, ground, or a smooth surface, etc. The apparatus 100 may be used as a recreational vehicle or a recreational craft. The apparatus 100 includes (and is not limited to) a combination of a user-platform assembly 102 and an air-thrusting assembly 104.

The user-platform assembly 102 is configured to support a user 902 in response to the user 902 standing (that is, being positioned) on the user-platform assembly 102 (in this way, the user-platform assembly 102 supports the weight of the user 902). The user-platform assembly 102 may also be called a board assembly. The user-platform assembly 102 may be used on the working surface 900. The user-platform assembly 102 is configured in such a way that the user 902 rides upon the user-platform assembly 102 in a standing position or crouching position. The user-platform assembly 102 is configured to receive and support the user 902 (an operator). The user-platform assembly 102 may require relatively better balance of the user 902 (also called the rider). In accordance with an option, the user-platform assembly 102 is configured to be carried by the user 902 once the user 902 no longer stands on (or is supported) by the user-platform assembly 102. In accordance with a specific option, the user-platform assembly 102 is configured to receive and support a weight of one and only one user 902. For instance, the user-platform assembly 102 includes a short oblong housing or an elongated housing or simply a housing assembly. The user-platform assembly 102 may include any suitable materials, such as wood, plastic, composite materials, metals, and/or light-weight materials that are structurally sound.

The air-thrusting assembly 104 is configured to provide an air flow for supporting the user-platform assembly 102 above (vertically above) the working surface 900 surface (such as, water, ice, snow, land, floor, any surface, etc.). The air-thrusting assembly 104 is operatively coupled to the user-platform assembly 102. The air-thrusting assembly 104 is configured to thrust air along a first direction 132 relative to the working surface 900. It will be appreciated that the air-thrusting assembly 104 operates (in use) in such a way that the air-thrusting assembly 104 urges the user-platform assembly 102 to vertically hover (along the first direction 132), at least in part, over the working surface 900. For instance, the first direction 132 is aligned perpendicular to the working surface 900.

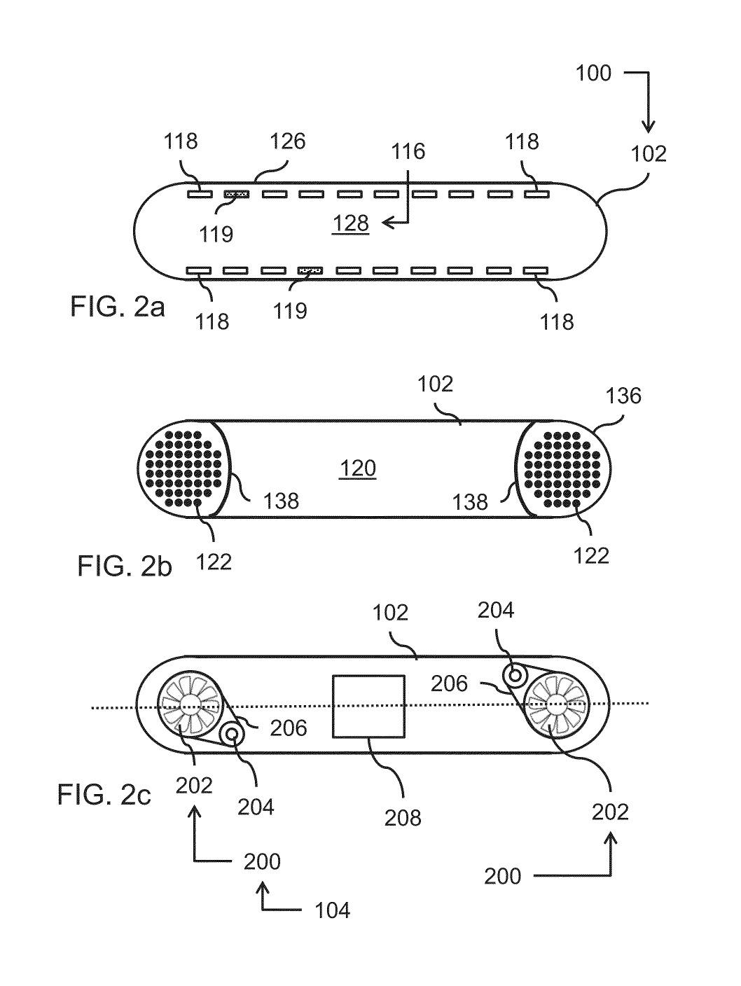

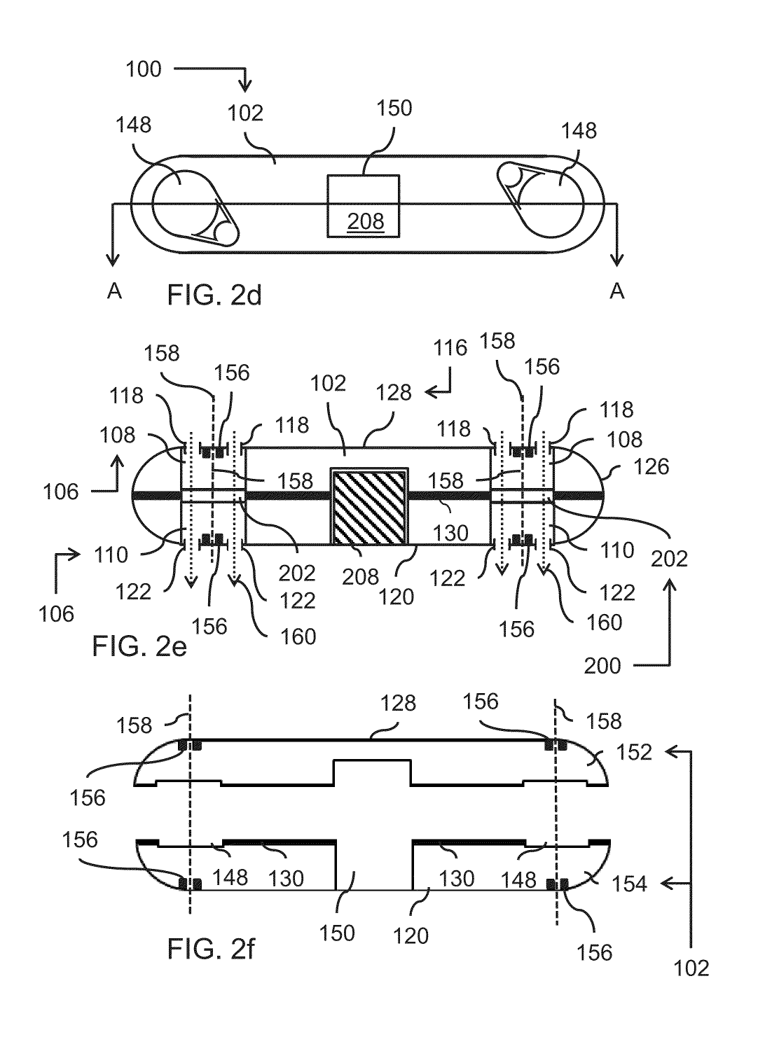

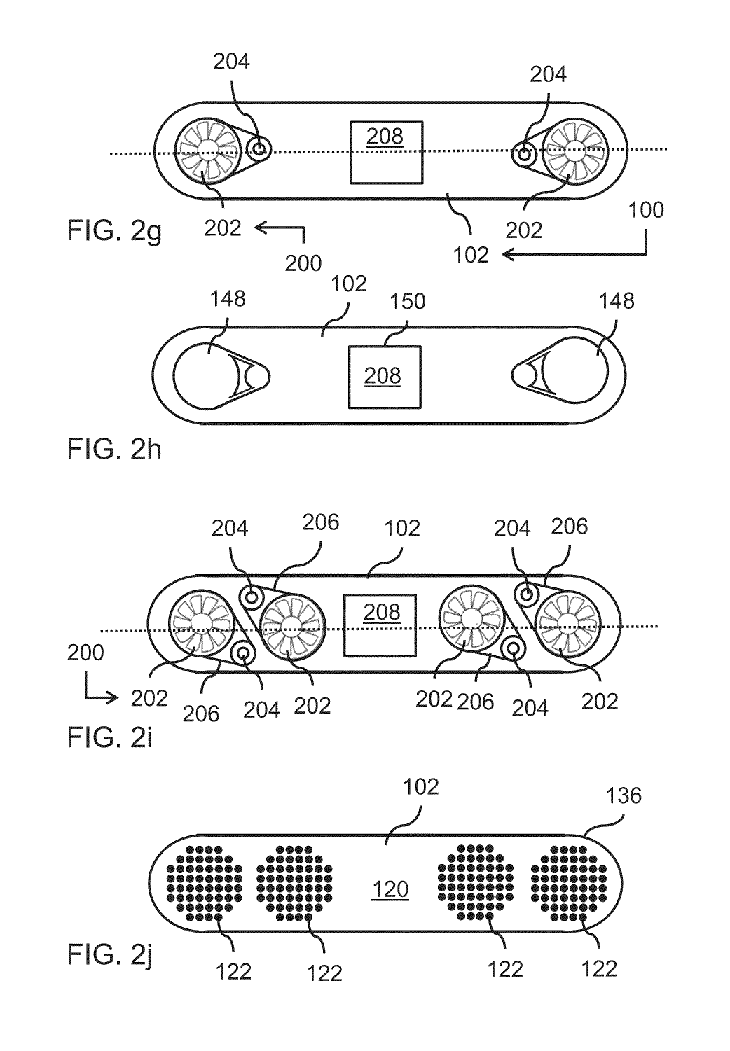

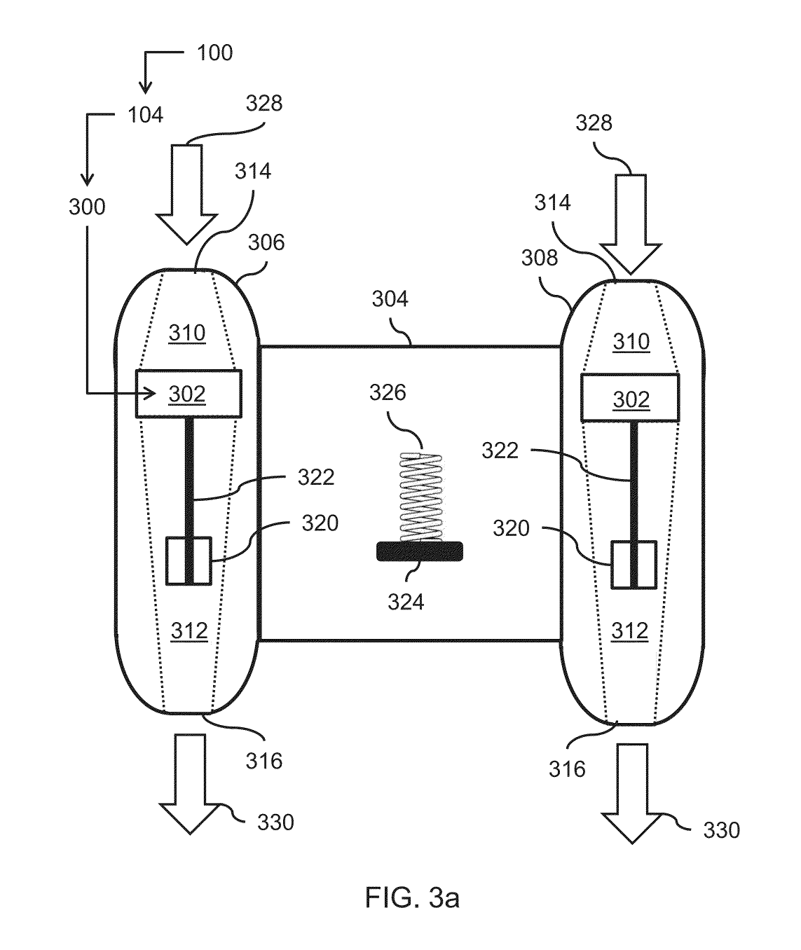

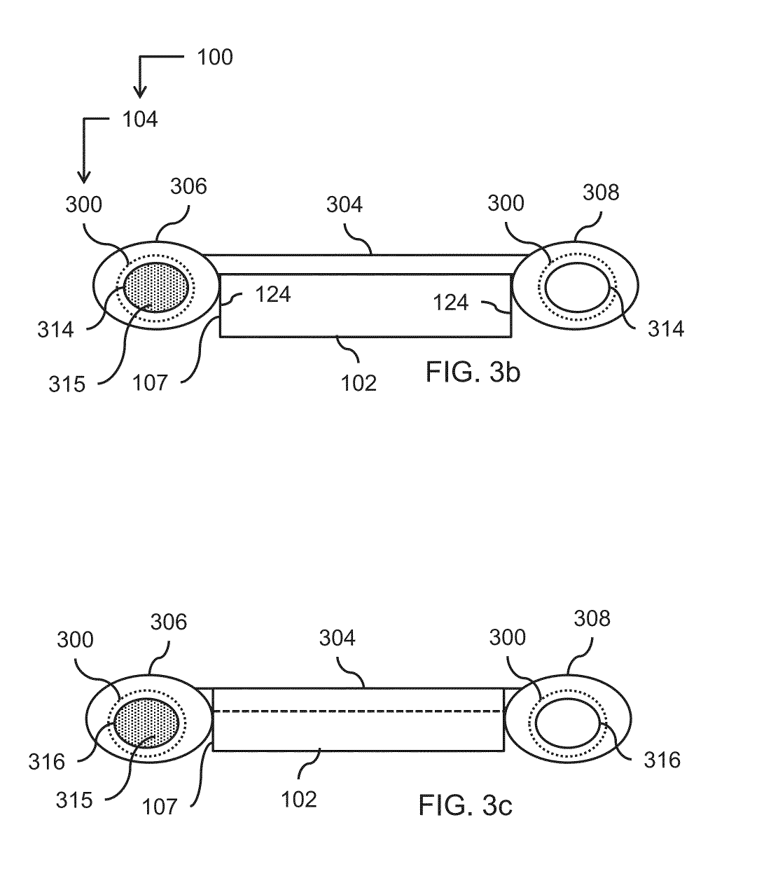

It will be appreciated that the first air-thrusting device 200 is depicted, in the various embodiment of FIGS. 2a to 2j, in such a way that the first air-thrusting device 200 is housed within (internally of) the user-platform assembly 102. It will be appreciated that the second air-thrusting device 300 is depicted, in the various embodiment of FIGS. 3a to 3c, in such a way that the second air-thrusting device 300 is housed externally of the user-platform assembly 102. In accordance with a first option to what is depicted, it will also be appreciated by persons of skill in the art that the first air-thrusting device 200 is housed externally of the user-platform assembly 102, and the second air-thrusting device 300 is housed internally of the user-platform assembly 102. In accordance with a second option to what is depicted, it will also be appreciated by persons of skill in the art that the first air-thrusting device 200 and the second air-thrusting device 300 are housed internally of the user-platform assembly 102. In accordance with a third option to what is depicted, it will also be appreciated that the first air-thrusting device 200 and the second air-thrusting device 300 are housed externally of the user-platform assembly 102.

The air-thrusting assembly 104 is also configured to thrust air along a second direction 134 relative to the working surface 900. It will be appreciated that the air-thrusting assembly 104 operates (in use) in such a way that the user-platform assembly 102 travels (along the second direction 134), at least in part, horizontally along the working surface 900 while the air-thrusting assembly 104 urges the user-platform assembly 102 to vertically hover, at least in part, over the working surface 900. The air-thrusting assembly 104 may also be called an air-propelling assembly, or an air-moving assembly; the air-thrusting assembly 104 is configured to actively forcefully move air directly along a predetermined direction (as opposed to deflecting moving air along a direction). For instance, the second direction 134 is aligned parallel to the working surface 900. The first direction 132 and the second direction 134 are different directions (not coaxially aligned with each other).

Referring to the embodiments depicted in FIGS. 1a, 1b, 1c and 1d, the apparatus 100 is further adapted (in accordance with an embodiment) such that the air-thrusting assembly 104 includes a combination of a first air-thrusting device 200 (also depicted in FIG. 2e) and a second air-thrusting device 300 (also depicted in FIG. 3a). The first air-thrusting device 200 and the second air-thrusting device 300 are configured to be user-controllable.

The first air-thrusting device 200 is operatively coupled to the user-platform assembly 102. The first air-thrusting device 200 is configured to thrust air along the first direction 132 relative to the working surface 900. The first air-thrusting device 200 is configured to operate in such a way that the first air-thrusting device 200 urges the user-platform assembly 102 to vertically hover, at least in part, over the working surface 900. For instance, the first air-thrusting device 200 is configured to receive air along an intake direction 144, and to expel forced air along an outtake direction 146.

The second air-thrusting device 300 is operatively coupled to the user-platform assembly 102. The second air-thrusting device 300 is configured to thrust air along the second direction 134 relative to the working surface 900. The second air-thrusting device 300 is configured to operate in such a way that the user-platform assembly 102 travels, at least in part, horizontally along the working surface 900 while the first air-thrusting device 200 urges the user-platform assembly 102 to vertically hover, at least in part, over the working surface 900. For instance, the second air-thrusting device 300 is configured to receive air along an intake direction 140, and to expel forced air along an outtake direction 142.

Referring to the embodiments depicted in FIGS. 1a and 1b, the apparatus 100 is further adapted (in accordance with an embodiment) such that the first air-thrusting device 200 is configured to thrust air in a vertical direction from the user-platform assembly 102 relative to the working surface 900. The second air-thrusting device 300 is configured to thrust air along a horizontal direction from the user-platform assembly 102 relative to the working surface 900.

Referring to the embodiments depicted in FIGS. 1a and 1b, the apparatus 100 is further adapted (in accordance with an embodiment) such that the first air-thrusting device 200 is configured to generate a cushion of air beneath the user-platform assembly 102. The first air-thrusting device 200 is configured to operate in such a way that the user-platform assembly 102 hovers, at least in part, vertically from the working surface 900.

Referring to the embodiment depicted in FIG. 1a, the apparatus 100 is further adapted (in accordance with an embodiment) such that the user-platform assembly 102 is configured to receive and support the weight of one and only one user. The apparatus 100 has weight and size that is convenient for the user to carry around unassisted (thus may be used in most urban areas, including parks, and most roads). The apparatus 100 may be transported by a single person, and may be used in places such as parks, or even sidewalks.

Referring to the embodiments depicted in FIGS. 1a and 1b, the apparatus 100 is further adapted (in accordance with an embodiment) such that the user-platform assembly 102 defines an interior chamber 106. The air-thrusting assembly 104 includes a first air-thrusting device 200. Additional details for the first air-thrusting device 200 are depicted in FIGS. 2a to 2j. The first air-thrusting device 200 is configured to vertically lift the user-platform assembly 102 above, at least in part, the working surface 900. Additional details for the second air-thrusting device 300 are depicted in FIGS. 3a to 3c.

Referring to the embodiment depicted in FIG. 1a, there is provided (in view of the above description for the apparatus 100) a method for operating the apparatus 100 relative to the working surface 900. The method includes (and is not limited to) an operational step of supporting the user 902 on the user-platform assembly 102. The method further includes an operational step of thrusting air along the first direction 132 relative to the working surface 900 from the air-thrusting assembly 104 operatively coupled to the user-platform assembly 102, and this is done in such a way that the air-thrusting assembly 104 urges the user-platform assembly 102 to vertically hover, at least in part, over the working surface 900. The method further includes an operational step of thrusting air along the second direction 134 relative to the working surface 900 from the air-thrusting assembly 104, and this is done in such a way that the user-platform assembly 102 travels, at least in part, horizontally along the working surface 900 while the air-thrusting assembly 104 urges the user-platform assembly 102 to vertically hover, at least in part, over the working surface 900.

Referring to the embodiment depicted in FIG. 1a, the apparatus 100 is further adapted (in accordance with an embodiment) such that the user-platform assembly 102 includes a bottom portion 120 and a lip 123 (a downward extending lip). The lip 123 is located or positioned along the bottom portion 120 of the user-platform assembly 102, around an outer edge (foot print) of the user-platform assembly 102 (and extends toward, at least in part, the working surface 900). The lip 123 is configured to allow for uniform and stable lift off of the user-platform assembly 102 by facilitating the release of a focused forced flow of air toward the working surface 900 (depicted in FIG. 1a). It will be appreciated that the lip 123 is optional.

Referring to the embodiments depicted in FIGS. 1c and 1d, the apparatus 100 is further adapted (in accordance with an embodiment) such that the user-platform assembly 102 defines an outer-facing exterior surface 107. The air-thrusting assembly 104 includes a second air-thrusting device 300. As depicted in FIGS. 1c and 1d, there are two instances of the second air-thrusting device 300 mounted on opposite lateral sides of the user-platform assembly 102. The horizontal thrust to be provided by the second air-thrusting device 300 may include a forward thrust (propulsion) or a reverse thrust (propulsion), depending on the manner in which the second air-thrusting device 300 is operationally activated. Additional details for the second air-thrusting device 300 are depicted in FIGS. 3a to 3c.

FIGS. 2a to 2j depict views of embodiments of the apparatus 100 to be operated relative to the working surface 900. FIG. 2a depicts a top view. FIG. 2b depicts a bottom view. FIGS. 2c and 2d depict internal schematic views along a longitudinal cross section through a middle portion of the apparatus 100. FIG. 2e depicts a side view through the cross-sectional line A-A of FIG. 2d. FIG. 2f depicts an exploded side view through the cross-sectional line A-A of FIG. 2d. FIGS. 2g, 2h and 2i depict internal schematic views along a longitudinal cross section through a middle portion of the apparatus 100. FIG. 2j depicts a bottom view.

Referring to the embodiments depicted in FIGS. 2a to 2j, the apparatus 100 is further adapted (in accordance with an embodiment) such that the user-platform assembly 102 defines an interior chamber 106. The air-thrusting assembly 104 includes the first air-thrusting device 200. The first air-thrusting device 200 includes a vertically-aligned fan 202. The vertically-aligned fan 202 is operatively mounted to the user-platform assembly 102 in the interior chamber 106 of the user-platform assembly 102. The vertically-aligned fan 202 is configured to generate a cushion of air between the user-platform assembly 102 and the working surface 900. The vertically-aligned fan 202 is configured to operate in such a way that the user-platform assembly 102 hovers, at least in part, above the working surface 900. It will be appreciated that the air-thrusting assembly 104 is configured to pressurize the interior chamber of the user-platform assembly 102. It will be appreciated that the air-thrusting assembly 104 may be mounted relative to the user-platform assembly 102 in any suitable (or convenient) manner or arrangement (such as, vertically, inclined relative to the vertical, etc.).

Referring to the embodiment depicted in FIG. 2a, the apparatus 100 is further adapted (in accordance with an embodiment) such that the user-platform assembly 102 includes a top-facing surface 128 (which may be generically referred to as a first surface portion 116). The top-facing surface 128 defines instances of the air-in portal 118. The instances of the air-in portal 118 are aligned along a row, one after the other. The instances of the air-in portal 118 are positioned on an outer edge region of the top-facing surface 128 (so that the user can reduce chances of interfering with the operation of the air-in portal 118). The air-in portal 118 is configured to receive the intake of air from the exterior of the user-platform assembly 102 to an interior of the user-platform assembly 102 (as depicted in FIG. 2e). In accordance with a variation in the embodiment depicted in FIG. 1b, a side-facing surface 126 of the user-platform assembly 102 defines the instances of the air-in portal 118.

Referring to the embodiment of FIG. 2a, a filter 119 (also called a screen) is positioned at each instance of the air-in portal 118. FIG. 2a depicts one instance of the filter 119 (for the sake of convenient illustration). The filter 119 may include a formed latticework configuration. The filter 119 is configured to prevent particulate matter from entering the user-platform assembly 102 and potentially jamming the first air-thrusting device 200.

Referring to the embodiment depicted in FIG. 2b, the apparatus 100 is further adapted (in accordance with an embodiment) such that the user-platform assembly 102 has the bottom portion 120 that is perforated from which air flows out of and generates the cushion of air, which the user-platform assembly 102 rests on. The user-platform assembly 102 may provide a skirt 138 mounted to an outer perimeter 136 of the user-platform assembly 102 (for keeping the cushion of air pressurized underneath the user-platform assembly 102 between the working surface 900 and the user-platform assembly 102). The skirt 138 may extend across the bottom portion 120 of the user-platform assembly 102 proximate to the air-out portal 122. The skirt 138 is configured to focus the air exiting from the air-out portal 122 toward the working surface 900 (depicted in FIG. 1a). It will be appreciated that the skirt 138 is optional. Groupings of the air-out portal 122 are provided for respective instances of the vertically-aligned fan 202 depicted in FIG. 2c. As depicted, the groupings of the air-out portal 122 are positioned on opposite end sections of the user-platform assembly 102.

Referring to the embodiment depicted in FIGS. 2c and 2e, the apparatus 100 is further adapted (in accordance with an embodiment) such that the vertically-aligned fan 202 includes a vertical-thrust motor assembly 204. The vertical-thrust motor assembly 204 is operatively coupled to the vertically-aligned fan 202. In response to operation of the vertical-thrust motor assembly 204, the vertical-thrust motor assembly 204 urges operative rotational movement of the vertically-aligned fan 202. The vertical-thrust motor assembly 204 is configured to operate in such a way that the vertically-aligned fan 202 imparts a vertical lifting force to the user-platform assembly 102 as a result of the vertically-aligned fan 202 operatively thrusting air from the exterior of the user-platform assembly 102 to the first interior chamber 108 and then to the second interior chamber 110, and then to the exterior of the user-platform assembly 102. The vertical-thrust motor assembly 204 includes, for example, an electric motor or a gas-driven motor. The vertically-aligned fan 202 thrusts (pumps or forcibly moves) air from the exterior of the user-platform assembly 102 to the first interior chamber 108 and then to the second interior chamber 110, and then to the exterior of the user-platform assembly 102. It will be appreciated that the first air-thrusting device 200 (or the vertically-aligned fan 202) may be aligned in any suitable (or convenient) directional alignment (such as, vertical, non-vertical, inclined to the vertical, etc.) relative to the orientation of the user-platform assembly 102.

Referring to the embodiment depicted in FIG. 2c, the apparatus 100 is further adapted (in accordance with an embodiment) such that the vertically-aligned fan 202 further includes a coupling mechanism 206. In general terms, the coupling mechanism 206 is configured to operatively couple (the shaft of) the vertical-thrust motor assembly 204 to (the shaft of) the vertically-aligned fan 202. For instance, the coupling mechanism 206 includes a belt (a belt drive), a gear (a gear drive), a chain (a chain drive), and/or a direct-drive device configured to directly connect (couple) the shaft of the vertical-thrust motor assembly 204 to the shaft of the vertically-aligned fan 202. Generally, the coupling mechanism 206 is configured to operatively couple the vertical-thrust motor assembly 204 to the vertically-aligned fan 202. The axis of the vertical-thrust motor assembly 204 is spaced apart from the axis of the vertically-aligned fan 202. The axis of each instance of the vertically-aligned fan 202 is positioned along a central longitudinal axis extending through the user-platform assembly 102. The axis of each instance of the vertical-thrust motor assembly 204 is spaced apart from the central longitudinal axis extending through the user-platform assembly 102.

Referring to the embodiment of FIG. 2c, the instances of the vertically-aligned fan 202 that are positioned on opposite sides of the user-platform assembly 102 are configured to operate in counter rotation relative to each other. The instances of the vertically-aligned fan 202 are mirror images of each other; in this manner, the vertically-aligned fan 202 are configured to thrust (force air movement) in the same direction but while rotating in opposite directions in relation to each other. The purpose for this is to assist in balancing out angular momentum and assist in preventing the user-platform assembly 102 from spinning out (rotating inadvertently) of control (along an undesired path).

Referring to the embodiment depicted in FIGS. 2c and 2e, the apparatus 100 is further adapted (in accordance with an embodiment) such that the vertically-aligned fan 202 further includes a battery assembly 208. The battery assembly 208 is supported by the user-platform assembly 102. The battery assembly 208 is selectively connectable to the vertical-thrust motor assembly 204. In response to operative connection of the battery assembly 208 to the vertical-thrust motor assembly 204, the vertical-thrust motor assembly 204 is operationally activated. The vertical-thrust motor assembly 204 and the battery assembly 208 are located in the first interior chamber 108, and are embedded in an inter-cavity barrier 130 (depicted in FIGS. 2e and 2f) provided by the user-platform assembly 102.

Referring to the embodiment depicted in FIG. 2d, the apparatus 100 is further adapted (in accordance with an embodiment) such that the user-platform assembly 102 is configured to define a house chamber 148. The house chamber 148 is dimensioned (shaped or configured) to operatively receive the vertically-aligned fan 202, the vertical-thrust motor assembly 204 and the coupling mechanism 206 depicted in FIG. 2c. The user-platform assembly 102 is configured to define a battery chamber 150 configured to operatively receive the battery assembly 208.

Referring to the embodiment depicted in FIG. 2e, the apparatus 100 is further adapted (in accordance with an embodiment) such that the interior chamber 106 of the user-platform assembly 102 includes the first interior chamber 108. The interior chamber 106 of the user-platform assembly 102 also includes the second interior chamber 110 that is spaced apart from the first interior chamber 108. The first interior chamber 108 and the second interior chamber 110 are in fluid communication with each other. The first interior chamber 108 is also called an upper cavity. The second interior chamber 110 is also called a lower cavity.

Referring to the embodiment depicted in FIG. 2e, the apparatus 100 is further adapted (in accordance with an embodiment) such that the user-platform assembly 102 provides a first surface portion 116 configured to not face, in operation, the working surface 900. The first surface portion 116 defines an air-in portal 118 (also depicted in FIGS. 1b and 2a) leading from an exterior of the user-platform assembly 102 to the first interior chamber 108. The air-in portal 118 is configured in such a way that the first interior chamber 108 is in operative fluid communication with the exterior of the user-platform assembly 102. The air-in portal 118 is configured to receive the intake of air from the exterior of the user-platform assembly 102 to the first interior chamber 108 of the user-platform assembly 102. For instance, examples of the first surface portion 116 include a side-facing surface 126 (also depicted in FIGS. 1d and 2a) of the user-platform assembly 102 or a top-facing surface 128 (also depicted in FIGS. 1d and 2a) of the user-platform assembly 102.

Referring to the embodiment depicted in FIG. 2e, the apparatus 100 is further adapted (in accordance with an embodiment) such that the user-platform assembly 102 provides a bottom portion 120 configured to face, in operation, the working surface 900. The bottom portion 120 defines an air-out portal 122 (also depicted in FIG. 2b) leading from the second interior chamber 110 to an exterior of the user-platform assembly 102. The air-out portal 122 is configured in such a way that the second interior chamber 110 is in operative fluid communication with the exterior of the user-platform assembly 102. The air-out portal 122 is configured to provide the out-take of air from the second interior chamber 110 to the exterior of the user-platform assembly 102.

Referring to the embodiment depicted in FIG. 2e, the apparatus 100 is further adapted (in accordance with an embodiment) such that the first air-thrusting device 200 is positioned between the first interior chamber 108 and the second interior chamber 110; this is done in such a way that the first air-thrusting device 200 thrusts air, at least in part, from the exterior of the user-platform assembly 102 to the first interior chamber 108 via the air-in portal 118, then to the second interior chamber 110, and then to an exterior of the user-platform assembly 102 via the air-out portal 122. It is understood that the concept of thrusting air includes pumping air in a forced manner. The vertically-aligned fan 202 is configured to generate a relatively higher air pressure in the second interior chamber 110, forcing the air through the air-out portal 122 (relatively smaller holes) formed on (positioned on) the bottom portion 120 (also called a bottom section) of the user-platform assembly 102. Since the air-out portal 122 (also known as outlet holes) is relatively small, the speed of airstream travelling through the air-out portal 122 is increased, thus increasing a stagnation pressure when the air stream strikes, at least in part, the working surface 900. The forced movement of air (forced airflow) from the air-out portal 122 is configured to generate the cushion of air between the working surface 900 and the bottom portion 120 of the user-platform assembly 102. In this manner, the user-platform assembly 102 floats (hovers) over the working surface 900. This arrangement generates a relatively higher-pressure region that the user-platform assembly 102 sits thereon, and thereby allows the user to stand on the user-platform assembly 102 and to float above the working surface 900 (such as, ground, floor or water, etc.). There is an airflow 160 that is set up (in operation) by the first air-thrusting device 200 (depicted as the vertically-aligned fan 202) in response to the activation of the vertically-aligned fan 202.

Referring to the embodiment depicted in FIG. 2e (and FIG. 2b), the apparatus 100 is further adapted (in accordance with an embodiment) such that the user-platform assembly 102 has the bottom portion 120 that is perforated from which air flows out of and generates the cushion of air, which the user-platform assembly 102 rests on. When the first air-thrusting device 200 is activated (turned on), the first air-thrusting device 200 operates to pump (thrust) air from the first interior chamber 108 to the second interior chamber 110. The first interior chamber 108 is exposed to the atmosphere so it is full of air. The first air-thrusting device 200 is configured to generate enough relatively higher air pressure (underneath the user-platform assembly 102 between the user-platform assembly 102 and the working surface 900) in the second interior chamber 110, forcing the air through the air-out portal 122 (small holes) located on the bottom portion 120 of the user-platform assembly 102. Since the instances of the air-out portal 122 are relatively small, the speed of airstream may be increased, thus increasing the stagnation pressure when the air stream strikes the working surface 900. The airflow from the air-out portal 122 then acts to generate a cushion of air underneath the user-platform assembly 102 (upon which the user-platform assembly 102 may float over the working surface 900). The user-platform assembly 102 is configured to glide on the cushion of air over the working surface 900. The user-platform assembly 102 may be turned or steered, at least partially, in response to the user acting to vary the user-weight distribution placed on the user-platform assembly 102. The air-thrusting assembly 104 is configured to push (thrust) air underneath the user-platform assembly 102. This arrangement generates a higher air pressure region beneath the user-platform assembly 102, which causes the user-platform assembly 102 to be lifted away from the working surface 900. The user-platform assembly 102 can float above land and/or water.

Referring to the embodiment depicted in FIG. 2f, the apparatus 100 is further adapted (in accordance with an embodiment) such that the user-platform assembly 102 includes a first section 152 (also called an upper section or an upper housing), and a second section 154 (also called a bottom section or a bottom housing). The first section 152 and the second section 154 are configured to selectively attach and detach from each other. The first section 152 and the second section 154 are configured to be snap-fitted together (in a secured arrangement or a locked arrangement). The first section 152 and the second section 154 define an inter-cavity barrier 130 positioned therein (between) once the first section 152 and the second section 154 are operationally mated together (as depicted in FIG. 2e). The first section 152 and the second section 154 define the battery chamber 150 once the first section 152 and the second section 154 are operationally mated together (as depicted in FIG. 2e). The first section 152 and the second section 154 define the house chamber 148 once the first section 152 and the second section 154 are operationally mated together (as depicted in FIG. 2e).

The user-platform assembly 102 is configured to provide or include a centering device 156 (such as protrusions, etc.) positioned to extend into the first interior chamber 108 and the second interior chamber 110 (as depicted in FIG. 2e). The centering device 156 is configured to receive and operatively mount the shaft of the vertically-aligned fan 202 (depicted in FIG. 2e) within the interior chamber 106 (that is, the first interior chamber 108 and the second interior chamber 110). A rotation axis 158 of the vertically-aligned fan 202 extends to (reaches to) the centering device 156. As depicted, each of the first section 152 and the second section 154 provides an instance of the centering device 156 aligned together (or face each other and spaced apart from each other) once the first section 152 and the second section 154 are operationally mated together (as depicted in FIG. 2e).

Referring to the embodiment depicted in FIG. 2g, the apparatus 100 is further adapted (in accordance with an embodiment) such that the axis of the vertical-thrust motor assembly 204 is spaced apart from the axis of the vertically-aligned fan 202. The axis of each instance of the vertically-aligned fan 202 is positioned along a central longitudinal axis extending through the user-platform assembly 102. The axis of each instance of the vertical-thrust motor assembly 204 is positioned along the central longitudinal axis extending through the user-platform assembly 102. The embodiment of FIG. 2g provides an alternative to the embodiment depicted in FIG. 2c.

Referring to the embodiment depicted in FIG. 2h, the apparatus 100 is further adapted (in accordance with an embodiment) such that the user-platform assembly 102 is configured to define the house chamber 148. The house chamber 148 is dimensioned (shaped or configured) to operatively receive the vertically-aligned fan 202, the vertical-thrust motor assembly 204 and the coupling mechanism 206 depicted in FIG. 2g. The user-platform assembly 102 is configured to define the battery chamber 150. The battery chamber 150 is configured to operatively receive the battery assembly 208. The embodiment of FIG. 2h provides an alternative to the embodiment depicted in FIG. 2d. The embodiment of FIG. 2h is configured to cooperate with the embodiment depicted in FIG. 2g.

Referring to the embodiment depicted in FIG. 2i, the apparatus 100 is further adapted (in accordance with an embodiment) such that the user-platform assembly 102 is configured to operatively house four instances of the vertically-aligned fan 202, the vertical-thrust motor assembly 204 and the coupling mechanism 206. The axis of each instance of the vertically-aligned fan 202 is positioned along a central longitudinal axis extending through the user-platform assembly 102. The axis of each instance of the vertical-thrust motor assembly 204 is spaced apart from the central longitudinal axis extending through the user-platform assembly 102.

Referring to the embodiment depicted in FIG. 2j, the apparatus 100 is further adapted (in accordance with an embodiment) such that the user-platform assembly 102 includes the bottom portion 120 configured to be used with the embodiment of the user-platform assembly 102 depicted in FIG. 2i. The user-platform assembly 102 has the bottom portion 120 that is perforated from which air flows out of and generates the cushion of air, which the user-platform assembly 102 rests on.

Groupings of the air-out portal 122 are provided for respective instances of the vertically-aligned fan 202 depicted in FIG. 2i.

FIGS. 3a to 3c depict views of embodiments of the apparatus 100 to be operated relative to the working surface 900. FIG. 3a depicts a top view. FIG. 3b depicts a frontal view. FIG. 3c depicts a rearward view.

Referring to the embodiments depicted in FIGS. 3a to 3c, the apparatus 100 is further adapted (in accordance with an embodiment) such that the user-platform assembly 102 defines an outer-facing exterior surface 107. The air-thrusting assembly 104 includes the second air-thrusting device 300. As depicted in the embodiments of FIGS. 7a to 7c, there are two instances of the second air-thrusting device 300 securely attached and positioned to opposite sides of the user-platform assembly 102. The horizontal thrust to be provided by the second air-thrusting device 300 may include a forward thrust (propulsion) or a reverse thrust (propulsion), depending on the manner in which the second air-thrusting device 300 is operationally activated. It will be appreciated that multiple instances of the second air-thrusting device 300 may be deployed (if so required) at various positions on the user-platform assembly 102. In accordance with the depicted embodiment, the second air-thrusting device 300 includes (and is not limited to) a horizontally-aligned fan 302. The horizontally-aligned fan 302 is operatively mounted to the outer-facing exterior surface 107. The horizontally-aligned fan 302 is configured to impart a horizontal thrust to the user-platform assembly 102. The horizontally-aligned fan 302 is configured to operate in such a way that the user-platform assembly 102 moves, at least in part, horizontally above the working surface 900. It will be appreciated that the second air-thrusting device 300 may be aligned in any suitable (or convenient) directional alignment (such as, vertical, non-vertical, inclined to the vertical, etc.) relative to the orientation of the user-platform assembly 102.

Referring to the embodiment of FIG. 3a, the instances of the horizontally-aligned fan 302 that are positioned on opposite sides of the user-platform assembly 102 are configured to operate in counter rotation relative to each other. The instances of the horizontally-aligned fan 302 are mirror images of each other; in this manner, the horizontally-aligned fan 302 are configured to thrust (force air movement) in the same direction but while rotating in opposite directions in relation to each other. The purpose for this is to assist in balancing out angular momentum and assist in preventing the user-platform assembly 102 from spinning out (rotating inadvertently) of control (along an undesired path).

Referring to the embodiments of FIGS. 3b and 3c, a filter 315 (also called a screen) is positioned at each instance of the air intake 314 and the air outtake 316. FIGS. 3b and 3c depict one instance of the filter 315 for the air intake 314 and the air outtake 316 (for the sake of convenient illustration). The filter 315 may include a formed latticework configuration. The filter 315 is configured to prevent particulate matter from entering the first tubular unit 306 and the second tubular unit 308 (generally, the second air-thrusting device 300) and potentially jamming the second air-thrusting device 300.

Referring to the embodiments depicted in FIGS. 3a to 3c, the apparatus 100 is further adapted (in accordance with an embodiment) such that the user-platform assembly 102 includes opposite sides 124 spaced apart from each other. The air-thrusting assembly 104 includes the second air-thrusting device 300. The second air-thrusting device 300 includes a horizontal section 304, a first tubular unit 306, and a second tubular unit 308 each of which are positioned on another side of the horizontal section 304 opposite from the first tubular unit 306. The horizontal section 304 spans across the opposite sides 124 of the user-platform assembly 102. The first tubular unit 306 is positioned on one side of the horizontal section 304 at a selected side of the user-platform assembly 102. The second tubular unit 308 is positioned on another side of the horizontal section 304 opposite from the first tubular unit 306. The first tubular unit 306 and the second tubular unit 308 are aligned parallel to each other. The first tubular unit 306 and the second tubular unit 308 are positioned and connected to a respective opposite side of the horizontal section 304. The second air-thrusting device 300 is also called a propulsion unit. The horizontal section 304 is also called a flat surface.

Referring to the embodiments depicted in FIGS. 3a to 3c, the apparatus 100 is further adapted (in accordance with an embodiment) such that the first tubular unit 306 and the second tubular unit 308 each defines a first interior cavity 310, a second interior cavity 312, an air intake 314, and an air outtake 316. The second interior cavity 312 is spaced apart from the first interior cavity 310. The first interior cavity 310 and the second interior cavity 312 are in fluid communication with each other. The air intake 314 leads from an exterior of the first tubular unit 306 and the second tubular unit 308 (so that the air may enter the first interior cavity 310); this is done in such a way that the first interior cavity 310 is in operative fluid communication with the exterior of the first tubular unit 306 and the second tubular unit 308. The air intake 314 is configured to receive the intake of air from the exterior of the first tubular unit 306 and the second tubular unit 308 (for taking in air to the first interior cavity 310). It will be appreciated that an air inflow direction 328 leads to the air intake 314, and an air outflow direction 330 leads away from the air outtake 316.

The air outtake 316 leads from the second interior cavity 312 to the exterior of the first tubular unit 306 and the second tubular unit 308, and this is done in such a way that the second interior cavity 312 is in operative fluid communication with the exterior of the first tubular unit 306 and the second tubular unit 308. The air outtake 316 is configured to provide the out-take of air from the second interior cavity 312 to the exterior of the first tubular unit 306 and the second tubular unit 308.

Referring to the embodiments depicted in FIGS. 3a to 3c, the apparatus 100 is further adapted (in accordance with an embodiment) such that the second air-thrusting device 300 is positioned between the first interior cavity 310 and the second interior cavity 312 in such a way that the second air-thrusting device 300 thrusts air, at least in part, from the exterior of the first tubular unit 306 and the second tubular unit 308 to the first interior cavity 310 via the air intake 314, then to the second interior cavity 312, and then to the exterior of the first tubular unit 306 and the second tubular unit 308 via the air outtake 316.

Referring to the embodiments depicted in FIGS. 3a to 3c, the apparatus 100 is further adapted (in accordance with an embodiment) such that the second air-thrusting device 300 includes a horizontally-aligned fan 302. The horizontally-aligned fan 302 is operatively mounted to each of the first interior cavity 310 and the second interior cavity 312 of the first tubular unit 306 and the second tubular unit 308. The horizontally-aligned fan 302 is configured to thrust air in such a way that the user-platform assembly 102 travels, at least in part, along the working surface 900 (depicted in FIG. 1a) while the user-platform assembly 102 hovers vertically, at least in part, above the working surface 900.

Referring to the embodiments depicted in FIGS. 3a to 3c, the apparatus 100 is further adapted (in accordance with an embodiment) such that the horizontally-aligned fan 302 includes a horizontal-thrust motor 320. The horizontal-thrust motor 320 is operatively coupled to the horizontally-aligned fan 302; in response to the operation of the horizontal-thrust motor 320, the horizontal-thrust motor 320 urges operative rotational movement of the horizontally-aligned fan 302; this is done in such a way that the horizontally-aligned fan 302 imparts a horizontal thrusting force to the first tubular unit 306 and the second tubular unit 308 as a result of the horizontally-aligned fan 302 operatively thrusting air from the exterior of the first tubular unit 306 and the second tubular unit 308 to the first interior cavity 310 (and then to the second interior cavity 312, and then to the exterior of the first tubular unit 306 and the second tubular unit 308). The horizontal-thrust motor 320 includes, for example, an electric motor or a gas-driven motor. The horizontally-aligned fan 302 is configured to thrust (pump or forcibly move) air.

Referring to the embodiments depicted in FIGS. 3a to 3c, the apparatus 100 is further adapted (in accordance with an embodiment) such that the horizontally-aligned fan 302 includes a horizontal-thrust shaft 322. The horizontal-thrust shaft 322 is configured to operatively couple the horizontal-thrust motor 320 to the horizontally-aligned fan 302.

Referring to the embodiments depicted in FIGS. 3a to 3c, the apparatus 100 is further adapted (in accordance with an embodiment) such that the horizontally-aligned fan 302 includes a battery assembly 208. The battery assembly 208 is supported by the user-platform assembly 102. The battery assembly 208 is selectively connectable to the horizontal-thrust motor 320. In response to the operative connection of the battery assembly 208 to the horizontal-thrust motor 320, the horizontal-thrust motor 320 is operationally activated. The second air-thrusting device 300 is configured to provide backward horizontal thrust when a control switch 324 is moved toward a forward position of the user-platform assembly 102, by turning the horizontally-aligned fan 302 located inside the first tubular unit 306 and the second tubular unit 308 of the second air-thrusting device 300 in opposing directions. The second air-thrusting device 300 is configured to provide a backward thrust as a breaking mechanism.

For instance, the control switch 324 includes a double pull double throw or DPDT rocker switch (and any equivalent). The control switch 324 is configured to selectively reverse the application of polarity of the battery assembly 208 for the electric current to be applied to the horizontal-thrust motor 320. In this way, rotation of the horizontally-aligned fan 302 may be selectively changed (reversed) between rotation directions (clockwise rotation and counter-clockwise rotation), and in this manner, forward horizontal propulsion and rearward horizontal propulsion of the user-platform assembly 102 is achieved.

The control switch 324 may be mounted to an outer surface of the horizontal section 304 of the second air-thrusting device 300 or to the outer surface of the user-platform assembly 102. The control switch 324 is biased (such as, biasing provided by a biasing mechanism 326). For instance, a spring assembly is attached to the control switch 324 so that in this manner the control switch 324 is configured to deactivate in the absence of a user-applied force received by the spring assembly. In other words, the user is required to apply a constant force to the spring assembly in order to maintain the application of the electric current to the horizontal-thrust motor 320. Once the constant force is not applied, the horizontal-thrust motor 320 is deactivated.

For the case where the control switch 324 is pressed (backwardly), the control switch 324 causes the horizontal-thrust motor 320 to generate a backward-directed thrust of air. The control switch 324 has a biasing mechanism 326 (such as a spring, etc.) so that the control switch 324 requires application of the constant force (from the user) to be activated. For the case where the second air-thrusting device 300 is selectively activated, the second air-thrusting device 300 generates horizontally directed thrust (forward thrust or reverse thrust).

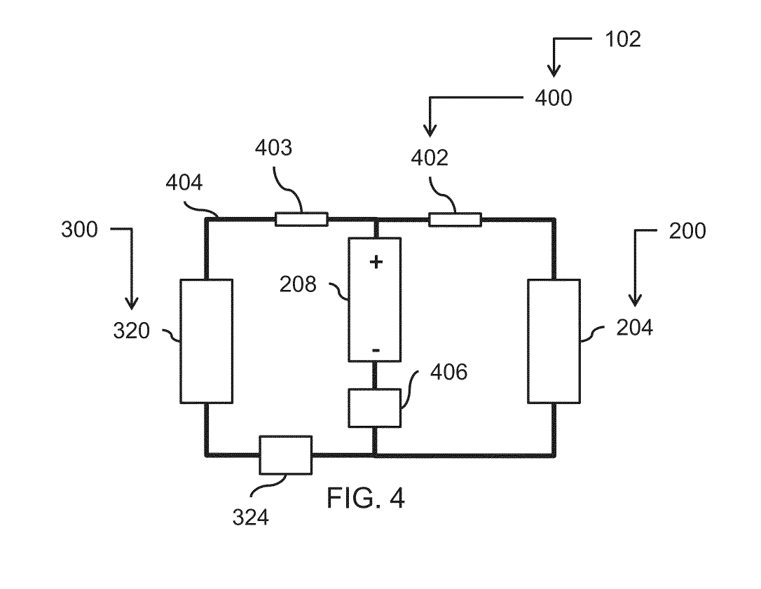

FIG. 4 depicts a schematic view of an embodiment of the apparatus 100 to be operated relative to the working surface 900.

Referring to the embodiment depicted in FIG. 4, the apparatus 100 is further adapted (in accordance with an embodiment) such that the user-platform assembly 102 includes a control circuit 400 configured to control the operation of the air-thrusting assembly 104. Specifically, the control circuit 400 is configured to control operation of the vertical-thrust motor assembly 204 associated with the first air-thrusting device 200 (depicted in FIGS. 2a to 2j), and to control operation of the horizontal-thrust motor 320 of the second air-thrusting device 300 (depicted in FIGS. 3a to 3c). The control circuit 400 is configured to control the power delivered from the battery assembly 208 to the vertical-thrust motor assembly 204 and the horizontal-thrust motor 320 (or instances of the vertical-thrust motor assembly 204 and the horizontal-thrust motor 320).

The control circuit 400 includes electrical components interconnected with conductors (wires). For instance, the control circuit 400 includes a first fuse assembly 402, a second fuse assembly 403, electrical conductors 404, and a power switch 406 (on/off switch), etc.

The control circuit 400 is configured to operatively connect the battery assembly 208 to the first fuse assembly 402; the vertical-thrust motor assembly 204 (of the first air-thrusting device 200) is operatively connected (electrically connected) to the first fuse assembly 402; the vertical-thrust motor assembly 204 is also operatively connected to the power switch 406; and the power switch 406 is operatively connected to the battery assembly 208. In response to changing the state of the power switch 406 between the ON state and the OFF state, power (electrical current) is selectively provided (delivered) to the vertical-thrust motor assembly 204, thereby selectively energizing and de-energizing the first air-thrusting device 200.

The control circuit 400 is configured to operatively connect the battery assembly 208 to the second fuse assembly 403; the horizontal-thrust motor 320 (of the second air-thrusting device 300) is operatively connected (electrically connected) to the second fuse assembly 403; the horizontal-thrust motor 320 is also operatively connected to the control switch 324 (depicted in FIG. 3a); the control switch 324 is operatively connected to the power switch 406; and the power switch 406 is operatively connected to the battery assembly 208. In response to changing the state of the power switch 406 between the ON state and the OFF state, power (electrical current) is selectively provided (delivered) to the horizontal-thrust motor 320, thereby selectively energizing and de-energizing the second air-thrusting device 300. In response to changing the state of the control switch 324 between the FORWARD state and the REVERSE state, power (electrical current) is selectively provided (delivered) to the horizontal-thrust motor 320 in such a way that the horizontal-thrust motor 320 selectively changes direction, thereby selectively causing the second air-thrusting device 300 to urge the apparatus 100 to go in a forward direction and a reverse direction (as may be required by the user by manipulation of the control switch 324).

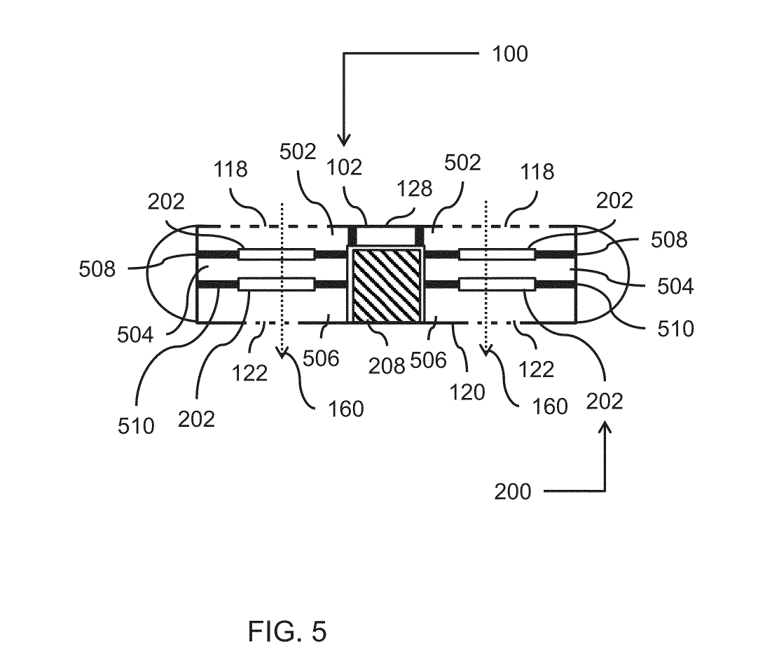

FIG. 5 depicts a side view of an embodiment of the apparatus 100 to be operated relative to the working surface 900.

Referring to the embodiment depicted in FIG. 5, the apparatus 100 is further adapted (in accordance with an embodiment) such that the user-platform assembly 102 includes or defines a first longitudinally-extending interior chamber 502, a second longitudinally-extending interior chamber 504, and a third longitudinally-extending interior chamber 506 (each spaced apart from each other in a vertically stacked arrangement). Below the top-facing surface 128 of the user-platform assembly 102 there is positioned a first horizontal interior wall 508 within the user-platform assembly 102 (the first horizontal interior wall 508 extends from opposite ends of the user-platform assembly 102). Above the bottom portion 120 of the user-platform assembly 102 there is positioned a second horizontal interior wall 510 within the user-platform assembly 102 (the second horizontal interior wall 510 extends from opposite ends of the user-platform assembly 102). At the opposite ends of the user-platform assembly 102, an instance of the vertically-aligned fan 202 (or the first air-thrusting device 200) is mounted to the first horizontal interior wall 508; this is done in such a way that the first longitudinally-extending interior chamber 502 and the second longitudinally-extending interior chamber 504 are in fluid communication via the vertically-aligned fan 202. At opposite ends of the user-platform assembly 102, an instance of the vertically-aligned fan 202 (or the first air-thrusting device 200) is mounted to the second horizontal interior wall 510; this is done in such a way that the second longitudinally-extending interior chamber 504 and the third longitudinally-extending interior chamber 506 are in fluid communication via the vertically-aligned fan 202. At opposite ends of the user-platform assembly 102, the instances of the vertically-aligned fan 202 (or the first air-thrusting device 200) are positioned so as to be stacked vertically relative to each other (one above the other) and spaced apart from each other. Between each internal chamber formed by or provided by the user-platform assembly 102, one or more instances of the vertically-aligned fan 202 are positioned there between in a stacked relationship. The instances of the vertically-aligned fan 202 (or the first air-thrusting device 200) are operated so as to force movement of air from the air-in portal 118, through the first longitudinally-extending interior chamber 502, past the vertically-aligned fan 202 (or the first air-thrusting device 200), through the second longitudinally-extending interior chamber 504, past the vertically-aligned fan 202 (or the first air-thrusting device 200), through the third longitudinally-extending interior chamber 506 and out from the air-out portal 122. In this manner, the apparatus 100 provides a multi-chambered configuration with instances of the vertically-aligned fan 202 (or the first air-thrusting device 200) separating the instances of the internal chambers of the user-platform assembly 102. The user-platform assembly 102 depicted in FIG. 5 is configured to reduce the pressure gradient extending across the instances of the vertically-aligned fan 202 (or the first air-thrusting device 200) that are operatively mounted in a stacked arrangement to each other (one above the other). The user-platform assembly 102 of FIG. 5 is configured to increase (at least in part) the pressure gradient from the top of the user-platform assembly 102 to the bottom of the user-platform assembly 102 (that is, the maximum pressure gradient is located or positioned below the bottom of the user-platform assembly 102 once the instances of the vertically-aligned fan 202 are energized and operative).

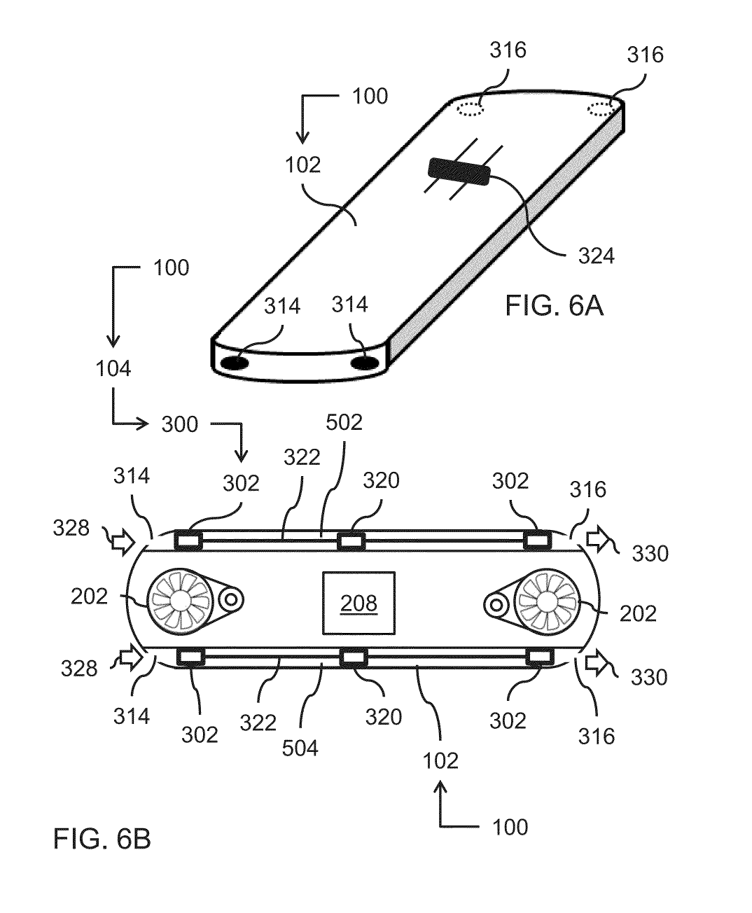

FIGS. 6A and 6B depict views of embodiments of the apparatus 100 to be operated relative to the working surface 900. FIG. 6a depicts a perspective view. FIG. 6b depicts a top view of the internal components of the apparatus 100 of FIG. 6a.

Referring to the embodiments depicted in FIGS. 6a and 6b, the apparatus 100 is further adapted (in accordance with an embodiment) such that the user-platform assembly 102 defines a first longitudinally-extending interior chamber 502 extending from the front section of the user-platform assembly 102 to the rear section of the user-platform assembly 102, and extends along the lateral peripheral side of the user-platform assembly 102. The user-platform assembly 102 also defines a second longitudinally-extending interior chamber 504 extending from the front section (the front end or simply the end section) of the user-platform assembly 102 to the rear section (the rear end or simply the end section) of the user-platform assembly 102, and extends along the lateral peripheral side of the user-platform assembly 102. The first longitudinally-extending interior chamber 502 and the second longitudinally-extending interior chamber 504 are positioned on the opposite lateral sides of the user-platform assembly 102 (and within the user-platform assembly 102). The user-platform assembly 102 defines the air intake 314 at one end portion of the user-platform assembly 102). The user-platform assembly 102 also defines the air outtake 316 at an opposite end portion of the user-platform assembly 102. The first longitudinally-extending interior chamber 502 is in fluid communication with the air intake 314 and the air outtake 316 that are positioned at one end portion (end section) of the user-platform assembly 102. The second longitudinally-extending interior chamber 504 is in fluid communication with the air intake 314 and the air outtake 316 that are positioned on the opposite end portion (end section) of the user-platform assembly 102.

The second air-thrusting device 300 includes instances of the horizontally-aligned fan 302 positioned in the first longitudinally-extending interior chamber 502 proximate to the air intake 314 and proximate to the air outtake 316. The horizontal-thrust motor 320 is positioned in the first longitudinally-extending interior chamber 502 between the air intake 314 and the air outtake 316 positioned at the opposite ends of the first longitudinally-extending interior chamber 502. The horizontal-thrust shaft 322 extends from the instances of the horizontally-aligned fan 302 to the horizontal-thrust motor 320. The horizontal-thrust motor 320 is configured to operative drive the instances of the horizontally-aligned fan 302 (connected by way of the horizontal-thrust shaft 322).

The second air-thrusting device 300 includes instances of the horizontally-aligned fan 302 positioned in the second longitudinally-extending interior chamber 504 proximate to the air intake 314 and proximate to the air outtake 316. The horizontal-thrust motor 320 is positioned in the second longitudinally-extending interior chamber 504 between the air intake 314 and the air outtake 316 positioned at the opposite ends of the second longitudinally-extending interior chamber 504. The horizontal-thrust shaft 322 extends from the instances of the horizontally-aligned fan 302 to the horizontal-thrust motor 320. The horizontal-thrust motor 320 is configured to operative drive the instances of the horizontally-aligned fan 302 (connected by way of the horizontal-thrust shaft 322).

In accordance with a first operation mode, the instances of the horizontal-thrust motor 320 are configured to be operated to cause the horizontally-aligned fan 302 to force movement of air flow along the air inflow direction 328 toward the air outflow direction 330 (this may be called the forward direction of movement of the user-platform assembly 102). In accordance with a second operation mode, the instances of the horizontal-thrust motor 320 may be operated to cause the instances of the vertically-aligned fan 202 to force movement of air flow in the opposite direction as indicated in FIG. 6b (this may be called the reverse direction of movement of the user-platform assembly 102). In accordance with a third operation mode, the instances of the horizontal-thrust motor 320 may be operated in such a way that the air flow may be forced to move (A) along the first longitudinally-extending interior chamber 502 and (B) along the second longitudinally-extending interior chamber 504, in opposite directions to each other in such a way that the user-platform assembly 102 may be rotated along a horizontal plane of rotation (along a plane of rotation that is parallel to the working surface while the user-platform assembly 102 that remains spaced apart from the working surface ,if so desired). It will be appreciated that the modes of operation (described above) may be applicable to the embodiment depicted in FIGS. 3a, 3b, 3c.

In accordance with FIG. 6a and FIG. 6b, the user-platform assembly 102 forms a built-in horizontally-aligned propulsion system. In this manner, the second air-thrusting device 300 is positioned within the user-platform assembly 102 instead of being mounted externally of the user-platform assembly 102 (as depicted in FIG. 3a). It will be appreciated that the first air-thrusting device 200 of FIGS. 2a to 2j are depicted as being mounted within the user-platform assembly 102; it will be appreciated that the first air-thrusting device 200 may be mounted externally of the user-platform assembly 102 (if so desired).

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

It may be appreciated that the assemblies and modules described above may be connected with each other as may be required to perform desired functions and tasks that are within the scope of persons of skill in the art to make such combinations and permutations without having to describe each and every one of them in explicit terms. There is no particular assembly, or components, that are superior to any of the equivalents available to the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for the purposes of this document, that the phrase “includes” is equivalent to the word “comprising.” It is noted that the foregoing has outlined the non-limiting embodiments (examples). The description is made for particular non-limiting embodiments (examples). It is understood that the non-limiting embodiments are merely illustrative as examples.

What is claimed is:

1. An apparatus to be operated relative to a working surface, the apparatus comprising:
a user-platform assembly being configured to support a user in response to the user being positioned on the user-platform assembly;
an air-thrusting assembly being operatively coupled to the user-platform assembly, and the air-thrusting assembly being configured to thrust air along:
a first direction relative to the working surface in such a way that the air-thrusting assembly urges the user-platform assembly to vertically hover, at least in part, over the working surface; and
a second direction relative to the working surface in such a way that the user-platform assembly travels, at least in part, horizontally along the working surface while the air-thrusting assembly urges the user-platform assembly to vertically hover, at least in part, over the working surface.

2. The apparatus of claim 1, wherein:
the air-thrusting assembly includes:
a first air-thrusting device being operatively coupled to the user-platform assembly, and the first air-thrusting device being configured to thrust air along the first direction relative to the working surface in such a way that the first air-thrusting device urges the user-platform assembly to vertically hover, at least in part, over the working surface; and
a second air-thrusting device being operatively coupled to the user-platform assembly, and the second air-thrusting device being configured to thrust air along the second direction relative to the working surface in such a way that the user-platform assembly travels, at least in part, horizontally along the working surface while the first air-thrusting device urges the user-platform assembly to vertically hover, at least in part, over the working surface.

3. The apparatus of claim 2, wherein:
the first air-thrusting device is configured to thrust air in a vertical direction from the user-platform assembly relative to the working surface; and
the second air-thrusting device is configured to thrust air along a horizontal direction from the user-platform assembly relative to the working surface.

4. The apparatus of claim 2, wherein:
the first air-thrusting device is configured to generate a cushion of air beneath the user-platform assembly in such a way that the user-platform assembly hovers, at least in part, vertically from the working surface.

5. The apparatus of claim 1, wherein:
the user-platform assembly defines an outer-facing exterior surface; and
the air-thrusting assembly includes:
a second air-thrusting device, including:
a horizontally-aligned fan being operatively mounted to the outer-facing exterior surface, and the horizontally-aligned fan being configured to impart a horizontal thrust to the user-platform assembly, in such a way that the user-platform assembly moves, at least in part, horizontally above the working surface.

6. The apparatus of claim 1, wherein:
the user-platform assembly defines an interior chamber; and
the air-thrusting assembly includes:
a first air-thrusting device including:
a vertically-aligned fan being operatively mounted to the user-platform assembly in the interior chamber of the user-platform assembly, and the vertically-aligned fan being configured to generate a cushion of air between the user-platform assembly and the working surface in such a way that the user-platform assembly hovers, at least in part, above the working surface.

7. The apparatus of claim 6, wherein:
the interior chamber of the user-platform assembly includes:
a first interior chamber; and
a second interior chamber being spaced apart from the first interior chamber, and the first interior chamber and the second interior chamber being in fluid communication with each other;
the user-platform assembly provides a first surface portion configured to not face, in operation, the working surface, the first surface portion defining an air-in portal leading from an exterior of the user-platform assembly to the first interior chamber in such a way that the first interior chamber is in operative fluid communication with the exterior of the user-platform assembly, and the air-in portal is configured to receive the intake of air from the exterior of the user-platform assembly to the first interior chamber of the user-platform assembly;
the user-platform assembly provides a bottom portion configured to face, in operation, the working surface, the bottom portion defining an air-out portal leading from the second interior chamber to an exterior of the user-platform assembly in such a way that the second interior chamber is in operative fluid communication with the exterior of the user-platform assembly, and the air-out portal is configured to provide out-take of air from the second interior chamber to the exterior of the user-platform assembly; and
the first air-thrusting device is positioned between the first interior chamber and the second interior chamber in such a way that the first air-thrusting device thrusts air, at least in part, from the exterior of the user-platform assembly to the first interior chamber via the air-in portal, then to the second interior chamber, and then to an exterior of the user-platform assembly via the air-out portal.

8. The apparatus of claim 7, wherein:
the vertically-aligned fan includes:
a vertical-thrust motor assembly being operatively coupled to the vertically-aligned fan, and in response to operation of the vertical-thrust motor assembly, the vertical-thrust motor assembly urges operative rotational movement of the vertically-aligned fan in such a way that the vertically-aligned fan imparts a vertical lifting force to the user-platform assembly as a result of the vertically-aligned fan operatively thrusting air from the exterior of the user-platform assembly to the first interior chamber and then to the second interior chamber, and then to the exterior of the user-platform assembly.

9. The apparatus of claim 8, wherein:
the vertically-aligned fan further includes:
a coupling mechanism being configured to operatively couple the vertical-thrust motor assembly to the vertically-aligned fan.

10. The apparatus of claim 8, wherein:
the vertically-aligned fan further includes:
a battery assembly being supported by the user-platform assembly, and the battery assembly being selectively connectable to the vertical-thrust motor assembly, and in response to operative connection of the battery assembly to the vertical-thrust motor assembly, the vertical-thrust motor assembly is operationally activated.

11. The apparatus of claim 1, wherein:
the user-platform assembly includes opposite sides being spaced apart from each other; and
the air-thrusting assembly includes:
a second air-thrusting device, including:
a horizontal section spanning across the opposite sides of the user-platform assembly;
a first tubular unit being positioned on one side of the horizontal section at a selected side of the user-platform assembly;
a second tubular unit being positioned on another side of the horizontal section opposite from the first tubular unit;
the first tubular unit and the second tubular unit being aligned parallel to each other; and
the first tubular unit and the second tubular unit being positioned and connected to a respective one of the opposite sides of the horizontal section.

12. The apparatus of claim 11, wherein:
the first tubular unit and the second tubular unit each defines:
a first interior cavity;
a second interior cavity being spaced apart from the first interior cavity, and the first interior cavity and the second interior cavity being in fluid communication with each other;
an air intake leading from an exterior of the first tubular unit and the second tubular unit to the first interior cavity in such a way that the first interior cavity is in operative fluid communication with the exterior of the first tubular unit and the second tubular unit, and the air intake is configured to receive the intake of air from the exterior of the first tubular unit and the second tubular unit to the first interior cavity; and
an air outtake leading from the second interior cavity to the exterior of the first tubular unit and the second tubular unit in such a way that the second interior cavity is in operative fluid communication with the exterior of the first tubular unit and the second tubular unit, and the air outtake is configured to provide out-take of air from the second interior cavity to the exterior of the first tubular unit and the second tubular unit; and
the second air-thrusting device is positioned between the first interior cavity and the second interior cavity in such a way that the second air-thrusting device thrusts air, at least in part, from the exterior of the first tubular unit and the second tubular unit to the first interior cavity via the air intake, then to the second interior cavity, and then to the exterior of the first tubular unit and the second tubular unit via the air outtake.

13. The apparatus of claim 12, wherein:
the second air-thrusting device includes:
a horizontally-aligned fan being operatively mounted to each of the first interior cavity and the second interior cavity of the first tubular unit and the second tubular unit, and the horizontally-aligned fan being configured to thrust air in such a way that the user-platform assembly travels, at least in part, along the working surface while the user-platform assembly hovers vertically, at least in part, above the working surface.

14. The apparatus of claim 13, wherein:
the horizontally-aligned fan includes:
a horizontal-thrust motor being operatively coupled to the horizontally-aligned fan, and in response to operation of the horizontal-thrust motor, the horizontal-thrust motor urges operative rotational movement of the horizontally-aligned fan in such a way that the horizontally-aligned fan imparts a horizontal thrusting force to the first tubular unit and the second tubular unit as a result of the horizontally-aligned fan operatively thrusting air from the exterior of the first tubular unit and the second tubular unit to the first interior cavity and then to the second interior cavity, and then to the exterior of the first tubular unit and the second tubular unit.

15. The apparatus of claim 14, wherein:
the horizontally-aligned fan includes:
a horizontal-thrust shaft being configured to operatively couple the horizontal-thrust motor to the horizontally-aligned fan.

16. The apparatus of claim 15, wherein:
the horizontally-aligned fan includes:
a battery assembly being supported by the user-platform assembly, and the battery assembly being selectively connectable to the horizontal-thrust motor, and in response to operative connection of the battery assembly to the horizontal-thrust motor, the horizontal-thrust motor is operationally activated.

17. The apparatus of claim 1, wherein:
the user-platform assembly includes:
a control circuit configured to control operation of the air-thrusting assembly.

18. The apparatus of claim 1, wherein:
the user-platform assembly is configured to receive and support a weight of one and only one user.

19. The apparatus of claim 1, wherein:
the user-platform assembly includes:
a bottom portion; and
a lip being located or positioned along the bottom portion of the user-platform assembly, around an outer edge of the user-platform assembly, and the lip being configured to allow for uniform and stable lift off of the user-platform assembly by releasing focused forced flow of air toward the working surface.

20. A method for operating an apparatus relative to a working surface, the method comprising:
supporting a user on a user-platform assembly;
thrusting air along a first direction relative to the working surface from an air-thrusting assembly being operatively coupled to the user-platform assembly, in such a way that the air-thrusting assembly urges the user-platform assembly to vertically hover, at least in part, over the working surface; and
thrusting air along a second direction relative to the working surface from the air-thrusting assembly, in such a way that the user-platform assembly travels, at least in part, horizontally along the working surface while the air-thrusting assembly urges the user-platform assembly to vertically hover, at least in part, over the working surface.
